(19) United States
(12) Patent Application Publication
(10) Pub. No.: US 2004/0149667 A1
(43) Pub. Date: Aug. 5, 2004

(54) Particle separator

(75) Inventor: James I. Meyer, Spearfish, SD (US)

Correspondence Address: NIXON & VANDERHYE, PC, 1100 N GLEBE ROAD, 8TH FLOOR, ARLINGTON, VA, 22201-4714, US

(73) Assignee: Ramvac Dental Products, Inc., Spearfish, SD (US)

(21) Appl. No.: 10/760,427

(22) Filed: Jan. 21, 2004

Related U.S. Application Data
(60) Provisional application No. 60/441,073, filed on Jan. 21, 2003.

(51) Int. Cl. B01D 17/00

(52) U.S. Cl. 210/787; 210/804; 210/532.1; 210/512.1

(57) ABSTRACT

A particle separator includes a vortex chamber receiving feed slurry via a feed inlet. The feed inlet is positioned relative to the vortex chamber to effect rotation of the feed slurry upon entry in the vortex chamber and to generate a fluid vortex. The vortex chamber includes a conical section beneath the feed inlet, wherein the conical section terminates at an apex. A bulb housing is coupled with the vortex chamber and includes a vortex destroyer disposed adjacent the conical section apex. The vortex destroyer serves to contain the fluid vortex to the vortex chamber. A settling chamber is defined by the bulb housing beneath the vortex destroyer for collecting solid particles.

### CROSS-REFERENCES TO RELATED APPLICATIONS

This application claims the benefit of U.S. Provisional Patent Application Serial No. 60/441,073, filed Jan. 21, 2003, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates generally to a centrifugal separator and, more particularly, to a hydrocyclone separating apparatus for separating solid particles from a feed slurry. In the present preferred application, the invention is used to separate amalgam particles from a dental treatment room vacuum system effluent, although the invention is not meant to be limited to this exemplary application.

Cyclones have been used for effective solid particle separation from fluids. FIG. 1 shows a cutaway view of a typical cyclone. The illustrated cyclone is a product of KREBS® Engineers of Tucson, Ariz. (www.krebs.com). During operation, the feed slurry enters the cyclone under pressure through the feed pipe into the top of the cylindrical feed chamber. As the feed enters the chamber, a rotation of the slurry inside the cyclone begins, causing centrifugal forces to accelerate the movement of the particles toward the outer wall. The particles migrate downward in a spiral pattern through the cylindrical section and into the conical section.

At this point, lower density particles migrate toward the center and spiral upward and out through the vortex finder, and discharge through the overflow pipe. This product, which contains the lower density particles and the majority of the fluid, is termed the overflow and should be discharged at ordinary atmospheric pressure.

The higher density particles remain in a downward spiral path along the walls of the conical section and gradually exit through the apex orifice. This product is termed the underflow and also should be discharged at or near atmospheric pressure.

This prior art cyclone arrangement requires a substantial portion of the feed slurry to exit the cyclone through the underflow. This is undesirable particularly in applications where it is only required to remove particles and allow a great majority of the fluid to pass through the overflow of the device.

### BRIEF SUMMARY OF THE INVENTION

The invention improves the typical cyclone by incorporating a settling chamber housed in a preferably removable bulb that can be removed and cleaned as necessary. The device includes structure to stop the fluid vortex from mixing the material in the settling chamber.

In an exemplary embodiment of the invention, a particle separator includes a vortex chamber receiving feed slurry via a feed inlet and a bulb housing coupled with the vortex chamber. The feed inlet is positioned relative to the vortex chamber to effect rotation of the feed slurry upon entry in the vortex chamber and to generate a fluid vortex. The vortex chamber includes a conical section beneath the feed inlet, which terminates at an apex. The bulb housing incorporates a vortex destroyer disposed adjacent the conical section apex that contains the fluid vortex to the vortex chamber. The bulb housing defines a settling chamber beneath the vortex destroyer that collects solid particles. The bulb housing is preferably removably coupled with the vortex chamber.

The vortex destroyer comprises at least one fin, and preferably a plurality of fins extending partially across a width of the bulb housing. The fin(s) may be substantially V-shaped fin and suspended from a bottom section of the vortex chamber into the bulb housing. In one embodiment, the bulb housing is cylindrical, and the plurality of substantially V-shaped fins are equally spaced about a circumference of the bulb housing. Generally, the vortex destroyer is configured such that solid materials in the feed slurry move radially outward from the conical section apex.

In another exemplary embodiment of the invention, a particle separator includes a feed inlet; a vortex chamber in fluid communication with the feed inlet and including a conical section beneath the feed inlet, wherein the conical section terminates at an apex; a bulb housing coupled with the vortex chamber; a vortex destroyer disposed in the bulb housing adjacent the conical section apex; and a settling chamber defined by the bulb housing beneath the vortex destroyer.

In yet another exemplary embodiment of the invention, a method of separating particles from a feed slurry using the particle separator of the invention is disclosed. The method includes the steps of flowing the feed slurry into the vortex chamber via the feed inlet and generating a fluid vortex; flowing the fluid vortex through the conical section apex; containing the fluid vortex to the vortex chamber with the vortex destroyer; permitting solid particles to move radially outward along the vortex destroyer; and collecting the solid particles in the settling chamber.

In still another exemplary embodiment of the invention, a vortex destroyer disposed within a bulb housing adjacent a vortex outlet of a vortex chamber is configured for containing a fluid vortex to the vortex chamber.

### BRIEF DESCRIPTION OF THE DRAWINGS

These and other aspects and advantages of the present invention will be described in detail with reference to the accompanying drawings, in which:

FIG. 1 is a cutaway view of a typical cyclone;

FIG. 2 is a cross-sectional view of the hydrocyclone design according to the present invention; and

FIG. 3 is a cutaway perspective view of the hydrocyclone illustrated in FIG. 2.

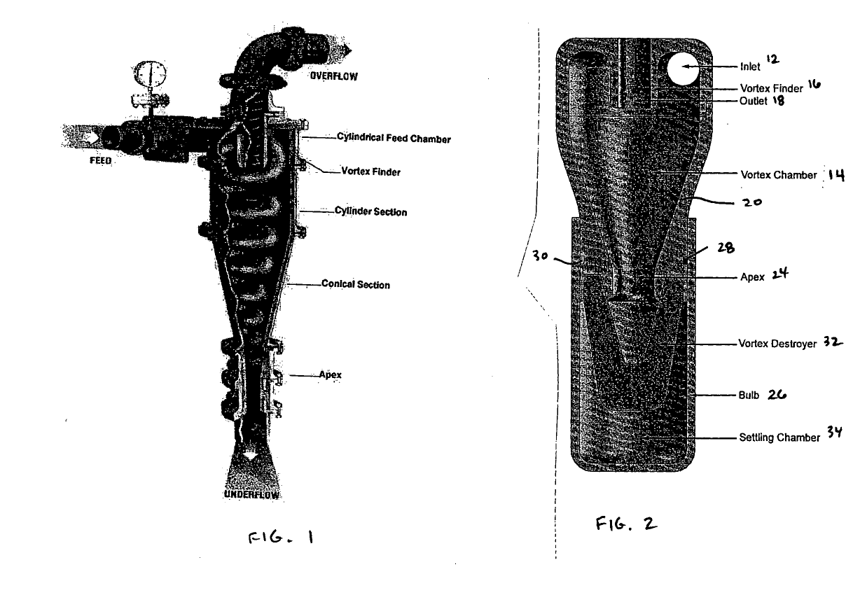

### DETAILED DESCRIPTION OF PREFERRED EMBODIMENTS

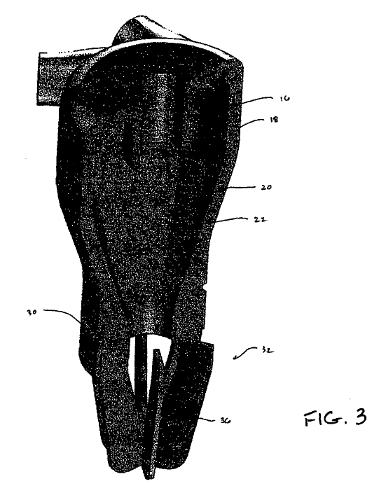

With reference to FIGS. 2 and 3, the device according to the present invention is a variation of the typical hydrocyclone design. The particle separate includes a feed inlet 12 in fluid communication with a vortex chamber 14. A vortex finder 16 and outlet 18 operate generally in the same manner as a standard hydrocyclone. The vortex chamber 14 includes a conical section 20 beneath the feed inlet 12. The conical section 20 terminates at an apex 24.

A bulb housing 26 is coupled with the vortex chamber 14 in any suitable manner. As shown, a circumferential slot 30 receives an O-ring 28, and the bulb housing 26 fits over the O-ring in a friction fit. Of course, any number of other attachment methods could be used, including without limitation, threads, cams, etc. Preferably, the bulb housing 26 is readily removable.

The bulb housing 26 houses a vortex destroyer 32 that is disposed adjacent the conical section apex 24. A settling chamber 34 is defined by the bulb housing 26 beneath the vortex destroyer 32.

FIG. 3 is a cutaway perspective view of the particle separator according to the present invention with the bulb housing 26 removed. With reference to FIG. 3, the vortex destroyer 32 comprises one or more fins 36 extending partially across a width of the bulb housing 26. The fins 36 are preferably fabricated from a flat material stock such as aluminum, steel or other metal or a plastic material. As shown, the fins 36 are preferably V-shaped and are suspended from a bottom section of the vortex chamber 14. The fins 36 may be secured in place to the vortex chamber 14 in any suitable manner, and preferably with a friction (press fit), glued in with a bonding agent, or mechanically secured by interlocking parts. The fins 36 may alternatively be attached to the bulb housing 26, or may be a separate part secured in place when the bulb housing 26 is installed. The fins 36 may also be molded as an integrated feature of the vortex chamber 14 or bulb housing 26. With a plurality of V-shaped fins 36, the fins are preferably disposed equally spaced about a circumference of the bulb housing. FIG. 3 illustrates three fins 36 defining six “panels” equally spaced about 60° apart.

The V-shaped construction requires the fluid exiting the apex 24 of the vortex chamber 14 to directly enter the vortex destroyer 32 at the top portion of the V-shape. Additionally, the tapered sides of the fins 36 provide an increasing space between the inside walls of the bulb housing 26 and the fins 36 of the vortex destroyer 32. As a consequence, the fins 36 permit solid materials to move radially out from the vortex into the settling chamber 34.

In operation, the vortex chamber 14 receives feed slurry via the feed inlet 12. Consistent with a conventional hydrocyclone apparatus, the feed inlet 12 is positioned relative to the vortex chamber 14 to effect rotation of the feed slurry upon entry in the vortex chamber 14 and to generate a fluid vortex. The vortex finder 16, outlet 18 and vortex chamber 14 operate in the same manner as a standard hydrocyclone. The conical section 20 increases the separation efficiency of the cyclone by reducing the radius of the vortex, thereby increasing the centrifugal load on the particles.

At the apex 24, the underflow discharges into the bulb housing 26 directly into the vortex destroyer 32. The vortex destroyer 32 stops the fluid vortex from mixing the material in the settling chamber 34; that is, the fins 36 serve to contain the fluid vortex to the vortex chamber 14.

As the vortex destroyer 32 stops the fluid vortex as fluid exits the apex 24, solid particles in the feed slurry move radially out from the vortex along the fins 36 and fall into the settling chamber 34. During operation, the settling chamber 34 fills with liquid and collects solid particles at the bottom. As noted, the bulb housing 26 is preferably removable for cleaning as necessary.

With the structure of the present invention, a particle separator prevents a substantial portion of the feed slurry from exiting the cyclone through the underflow, as is disadvantageously required with conventional systems. The structure is particularly suited for applications where it is only required to remove particles and allow a great majority of the fluid to pass through the overflow of the device.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A particle separator comprising:
a vortex chamber receiving feed slurry via a feed inlet, the feed inlet being positioned relative to the vortex chamber to effect rotation of the feed slurry upon entry in the vortex chamber and to generate a fluid vortex, the vortex chamber comprising a conical section beneath the feed inlet, wherein the conical section terminates at an apex; and
a bulb housing coupled with the vortex chamber, the bulb housing comprising a vortex destroyer disposed adjacent the conical section apex, wherein the vortex destroyer contains the fluid vortex to the vortex chamber, the bulb housing defining a settling chamber beneath the vortex destroyer that collects solid particles.

2. A particle separator according to claim 1, wherein the bulb housing is removably coupled with the vortex chamber.

3. A particle separator according to claim 1, wherein the vortex destroyer comprises at least one fin extending partially across a width of the bulb housing.

4. A particle separator according to claim 3, wherein the vortex destroyer comprises a plurality of fins.

5. A particle separator according to claim 1, wherein the vortex destroyer comprises at least one substantially V-shaped fin suspended from a bottom section of the vortex chamber into the bulb housing.

6. A particle separator according to claim 5, wherein the vortex destroyer comprises a plurality of substantially V-shaped fins.

7. A particle separator according to claim 6, wherein the bulb housing is cylindrical, and wherein the plurality of substantially V-shaped fins are equally spaced about a circumference of the bulb housing.

8. A particle separator according to claim 1, wherein the vortex destroyer is configured such that solid materials in the feed slurry move radially outward from the conical section apex.

9. A particle separator comprising:
a feed inlet;
a vortex chamber in fluid communication with the feed inlet and including a conical section beneath the feed inlet, wherein the conical section terminates at an apex;
a bulb housing coupled with the vortex chamber;
a vortex destroyer disposed in the bulb housing adjacent the conical section apex; and
a settling chamber defined by the bulb housing beneath the vortex destroyer.

10. A particle separator according to claim 9, wherein the bulb housing is removably coupled with the vortex chamber.

11. A particle separator according to claim 9, wherein the vortex destroyer comprises at least one fin extending partially across a width of the bulb housing.

12. A particle separator according to claim 9, wherein the vortex destroyer comprises at least one substantially V-shaped fin suspended from a bottom section of the vortex chamber into the bulb housing.

13. A method of separating particles from a feed slurry using the particle separator of claim 1, the method comprising:
flowing the feed slurry into the vortex chamber via the feed inlet and generating a fluid vortex;
flowing the fluid vortex through the conical section apex;
containing the fluid vortex to the vortex chamber with the vortex destroyer;
permitting solid particles to move radially outward along the vortex destroyer; and
collecting the solid particles in the settling chamber.

14. A vortex destroyer disposed within a bulb housing adjacent a vortex outlet of a vortex chamber, the vortex destroyer configured for containing a fluid vortex to the vortex chamber.

15. A vortex destroyer according to claim 14, comprising at least one fin extending partially across a width of the bulb housing.

16. A vortex destroyer according to claim 12, comprising a plurality of fins.

17. A vortex destroyer according to claim 14, comprising at least one substantially V-shaped fin suspended from a bottom section of the vortex chamber into the bulb housing.

18. A vortex destroyer according to claim 17, comprising a plurality of substantially V-shaped fins.

19. A vortex destroyer according to claim 18, wherein the bulb housing is cylindrical, and wherein the plurality of substantially V-shaped fins are equally spaced about a circumference of the bulb housing.

20. A vortex destroyer according to claim 14, configured relative to the bulb housing such that solid materials in a feed slurry from the vortex chamber move radially outward from the vortex outlet.
